(19) United States
(12) Patent Application Publication
(10) Pub. No.: US 2003/0023438 A1
(43) Pub. Date: Jan. 30, 2003

(54) Method and system for the training of parameters of a pattern recognition system, each parameter being associated with exactly one realization variant of a pattern from an inventory

(76) Inventors: Hauke Schramm, Roetgen-Mulartshuette (DE); Peter Beyerlein, Aachen (DE)

Correspondence Address: U.S. Philips Corporation, 580 White Plains Road, Tarrytown, NY, 10591, US

(21) Appl. No.: 10/125,445

(22) Filed: Apr. 18, 2002

(30) Foreign Application Priority Data
Apr. 20, 2001 (EP) 10119284.3

(51) Int. Cl. G10L 15/00

(52) U.S. Cl. 704/240

(57) ABSTRACT

The invention relates to a method of training parameters of a pattern recognition system, each parameter being associated with exactly one realization variant of a pattern from an inventory, comprising the steps of:

making available a training set of patterns, and

determining the parameters through discriminative optimization of a target function, and to a system for carrying out the above method.

Method and system for the training of parameters of a pattern recognition system, each parameter being associated with exactly one realization variant of a pattern from an inventory

The invention relates to a method and a system for the training of parameters of a pattern recognition system, each parameter being associated with exactly one realization variant of a pattern from an inventory, and in particular to a method and a system for the training of parameters of a speech recognition system which are each associated with exactly one pronunciation variant of a word from a vocabulary.

Pattern recognition systems, and in particular speech recognition systems, are used for a large number of applications. Examples are automatic telephone information systems such as, for example, the flight information service of the German air carrier Lufthansa, automatic dictation systems such as, for example, FreeSpeech of the Philips Company, handwriting recognition systems such as the automatic address recognition system used by the German Postal Services, and biometrical systems which are often proposed for personal identification, for example for the recognition of fingerprints, the iris, or faces. Such pattern recognition systems may in particular also be used as components of more general pattern processing systems, as is evidenced by the example of personal identification mentioned above.

Many known systems use statistical methods for comparing unknown test patterns with reference patterns known to the system for the recognition of these test patterns. The reference patterns are characterized by means of suitable parameters, and the parameters are stored in the pattern recognition system. Thus, for example, many pattern recognition systems use a vocabulary of single words as the recognition units, which are subsequently subdivided into so-termed sub-word units for an acoustical comparison with an unknown spoken utterance. These “words” may be words in the linguistic sense, but it is usual in speech recognition to interpret the notion “word” more widely. In a spelling application, for example, a single letter may constitute a word, while other systems use syllables or statistically determined fragments of linguistic words as words for the purpose of their recognition vocabularies.

The problem in automatic speech recognition lies inter alia in the fact that words may be pronounced very differently. Such differences arise on the one hand between different speakers, may follow from a speaker's state of mind, or are influenced by the dialect used by the speaker in the articulation of the word. On the other hand, very frequent words may in particular be spoken with a different sound sequence in spontaneous speech as compared with the sequence typical of carefully read-aloud speech. Thus, for example, it is usual to shorten the pronunciation of words: “would” may become “'d” and “can” may become “c'n”.

Many systems use so-termed pronunciation variants for modeling different pronunciations of one and the same word. If, for example, the l^{th} word wₗ of a vocabulary V can be pronounced in different ways, the j^{th} manner of pronunciation of this word may be modeled through the introduction of a pronunciation variant vₗⱼ. The pronunciation variant vₗⱼ is then composed of those sub-word units which fit the j^{th} manner of pronunciation of wₗ. Phonemes, which model the elementary sounds of a language, may be used as the sub-word units for forming the pronunciation variants. However, statistically derived sub-word units are also used. So-termed Hidden Markov Models are often used as the lowest level of acoustical modeling.

The concept of a pronunciation variant of a word as used in speech recognition was clarified above, but this concept may be applied in a similar manner to the realization variant of a pattern from an inventory of a pattern recognition system. The words from a vocabulary in a speech recognition system correspond to the patterns from the inventory, i.e. the recognition units, in a pattern recognition system. Just as words may be pronounced differently, so may the patterns from the inventory be realized in different ways. Words may thus be written differently manually and on a typewriter, and a given facial expression such as, for example, a smile, may be differently constituted in dependence on the individual and the situation. The considerations of the invention are accordingly applicable to the training of parameters associated with exactly one realization variant of a pattern from an inventory in a general pattern recognition system, although for reasons of economy they are disclosed in the present document mainly with reference to a speech recognition system.

As was noted above, many pattern recognition systems compare an unknown test pattern with the reference patterns stored in their inventories so as to determine whether the test pattern corresponds to any, and if so, to which reference pattern. The reference patterns are for this purpose provided with suitable parameters, and the parameters are stored in the pattern recognition system. Pattern recognition systems based in particular on statistical methods then calculate scores indicating how well a reference pattern matches a test pattern and subsequently attempt to find the reference pattern with the highest possible score, which will then be output as the recognition result for the test pattern. Following such a general procedure, scores will be obtained in accordance with pronunciation variants used, indicating how well a spoken utterance matches a pronunciation variant and how well the pronunciation variant matches a word, i.e. in the latter case a score as to whether a speaker has pronounced the word in accordance with this pronunciation variant.

Many speech recognition systems use as their scores quantities which are closely related to probability models. This may be constituted as follows, for example: it is the task of the speech recognition system to find for a spoken utterance x that word sequence ŵ₁^{N}=(ŵ₁, ŵ₂, . . . , ŵ_{N}) of N words, N being unknown, which of all possible word sequences w₁^{N}′ with all possible lengths N′ optimally matches the spoken utterance x, i.e. having the highest conditional probability in view of the condition x:

$${\hat{w}}_{1}^{N} = arg {max}_{{w}_{1}^{{N}^{′}}} p ( {w}_{1}^{{N}^{′}} \vert x ) . \qquad ( 1 )$$

Applying the Bayes' theorem yields a known model partition:

$${\hat{w}}_{1}^{N} = arg {max}_{{w}_{1}^{{N}^{′}}} p ( x \vert {w}_{1}^{{N}^{′}} ) \cdot p ( {w}_{1}^{{N}^{′}} ) . \qquad ( 2 )$$

The possible pronunciation variants v₁^{N}′ associated with the word sequence w₁^{N}′ can be introduced by summation:

$$p ( x \vert {w}_{1}^{{N}^{′}} ) = {\sum }_{{v}_{1}^{{N}^{′}}} p ( x \vert {v}_{1}^{{N}^{′}} ) \cdot p ( {v}_{1}^{{N}^{′}} \vert {w}_{1}^{{N}^{′}} ) , \qquad ( 3 )$$

because it is assumed that the dependence of the spoken utterance x on the pronunciation variant v₁^{N}′ and the word sequence w₁^{N}′ is defined exclusively by the sequence of pronunciation variants v₁^{N}′.

For further modeling of the dependence p(v₁^{N}′|w₁^{N}′), a so-termed unigram assumption is usually made, which disregards context influences:

$$p ( {v}_{1}^{{N}^{′}} \vert {w}_{1}^{{N}^{′}} ) = {\prod }_{i = 1}^{{N}^{′}} p ( {v}_{i} \vert {w}_{i} ) . \qquad ( 4 )$$

If the l^{th} word of the vocabulary V of the speech recognition system is denoted w₁, the j^{th} pronunciation variant of this word is denoted vₗⱼ, and the frequency with which the pronunciation variant vₗⱼ occurs in the sequence of pronunciation variants v₁^{N}′ is denoted hₗⱼ(v₁^{N}′) (for example, the frequency of the pronunciation variant “cuppa” in the utterance “give me a cuppa coffee” is 1, but that of the pronunciation variant “cup of” is 0), then the latter expression may also be written:

$$p ( {v}_{1}^{{N}^{′}} \vert {w}_{1}^{{N}^{′}} ) = {\prod }_{l = 1}^{D} {[ p ( {v}_{lj} \vert {w}_{l} ) ]}^{{h}_{lj} ( {v}_{1}^{{N}^{′}} )} , \qquad ( 5 )$$

in which the product is now formed for all D words of the vocabulary V.

The quantities p(vₗⱼ|wₗ), i.e. the conditional probabilities that the the pronunciation variant vₗⱼ is spoken for the word wₗ, are parameters of the speech recognition system which are each associated with exactly one pronunciation variant of a word from the vocabulary in this case. They are estimated in a suitable manner in the course of the training of the speech recognition system by means of a training set of spoken utterances available in the form of acoustical speech signals, and their estimated values are introduced into the scores of the recognition alternatives in the process of recognition of unknown test patterns on the basis of the above formulas.

Where the probability procedure usual in pattern recognition was used in the above discussion, it will be obvious to those skilled in the art that general evaluation functions are usually applied in practice which do not fulfill the conditions of a probability. Thus, for example, the standardization condition is often not regarded as necessary of fulfillment, or instead of a probability p , a quantity p^{λ}exponentially modified with a parameter λ is often used. Many systems also operate with the negative logarithms of these quantities: −λ log p , which are then often regarded as the “scores”. When probabilities are mentioned in the present document, accordingly, the more general evaluation functions familiar to those skilled in the art are also deemed to be included in this term.

Training of the parameters p(vₗⱼ, |wₗ) of a speech recognition system, which are each associated with exactly one pronunciation variant vₗⱼ of a word wₗ from a vocabulary, involves the use of a “maximum likelihood” method in many speech recognition systems. It can thus be determined, for example, in the training set how often the respective variants vₗⱼ of the word wₗ are pronounced. The relative frequencies ƒᵣₑₗ(vₗⱼ|wₗ) observed from the training set then serve, for example, directly as estimated values for the parameters p(vₗⱼ|wₗ) or alternatively are first subjected to known statistical smoothing operations such as, for example, discounting.

U.S. Pat. No. 6,076,053 by contrast discloses a method by which the pronunciation variants of a word from a vocabulary are merged into a pronunciation networks structure. The arcs of such a pronunciation network structure consist of the sub-word units, for example phonemes in the form of HMMs (“sub-word (phoneme) HMMs assigned to the specific arc”), of the pronunciation variants. To answer the question whether a certain pronunciation variant vₗⱼ of a word wₗ from the vocabulary was spoken, weight multiplicative, weight additive, and phone duration dependent weight parameters are introduced at the level of the arcs of the pronunciation network, or alternatively at the sub-level of the HHM states of the arcs.

In the method proposed in U.S. Pat. No. 6,076,053, the scores p(vₗⱼ|wₗ) are not used. Instead, in using the weight parameters e.g. at the arc level, a score ρⱼ^{(k)} is assigned to arc j in the pronunciation network for the k^{th} word, ρⱼ^{(k)} being for example a (negative) logarithm of the probability. In arc level weighting an arc j is assigned a score ρⱼ^{(k)}. In a presently preferred embodiment, this score is a logarithm of the likelihood.) This score is subsequently modified with a weight parameter. (“Applying arc level weighting leads to a modified score gⱼ^{(k)}: gⱼ^{(k)}=uⱼ^{(k)}·ρⱼ^{(k)}+cⱼ^{(k)}”). The weight parameters themselves are determined by discriminative training, for example through minimizing of the classification error rate in a training set (“optimizing the parameters using a minimum classification error criterion that maximizes a discrimination between different pronunciation networks”).

The invention has for its object to provide a method and a system for the training of parameters of a pattern recognition system, each pattern being associated with exactly one realization variant of a pattern from an inventory, and in particular to a method and a system for the training of parameters of a speech recognition system which are each associated with exactly one pronunciation variant of a word from a vocabulary, wherein the pattern recognition system is given a high degree of accuracy in the recognition of unknown test patterns.

This object is achieved by means of a method of training parameters of a pattern recognition system, each parameter being associated with exactly one realization variant of a pattern from an inventory, which method comprises the steps of:

making available a training set of patterns, and

determining the parameters through discriminative optimization of a target function,

and by means of a system for the training of parameters of a pattern recognition system, each parameter being associated with exactly one realization variant of a pattern from an inventory, which system is designed for:

making available a training set of patterns, and

determining the parameters through discriminative optimization of a target function,

and in particular by means of a method of training parameters of a speech recognition system, each parameter being associated with exactly one pronunciation variant of a word from a vocabulary, which method comprises the steps of:

making available a training set of acoustical speech signals, and

determining the parameters through discriminative optimization of a target function,

as well as by means of a system for the training of parameters of a speech recognition system, each parameter being associated with exactly one pronunciation variant of a word from a vocabulary, which system is designed for:

making available a training set of acoustical speech signals, and

determining the parameters through discriminative optimization of a target function.

The dependent claims 2 to 5 relate to advantageous further embodiments of the invention. They relate to the form in which the parameters are assigned to the scores p(vₗⱼ|wₗ), the details of the target function, the nature of the various scores, and the method of optimizing the target function.

In claims 9 and 10, however, the invention relates to the parameters themselves which were trained by a method as claimed in claim 7 as well as to any data carriers on which such parameters are stored.

### These and further aspects of the invention will be explained in more detail below with reference to embodiments and the appended drawing, in which:

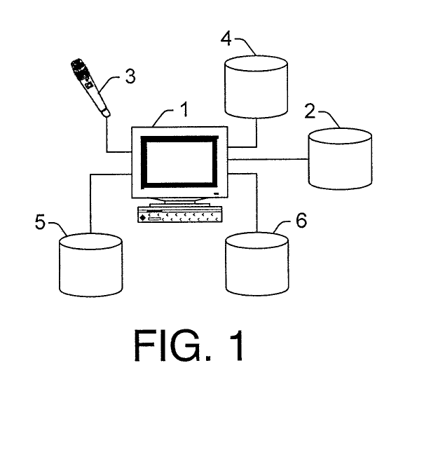

FIG. 1 shows an embodiment of a system according to the invention for the training of parameters of a speech recognition system which are each associated with exactly one pronunciation variant of a word from a vocabulary, and

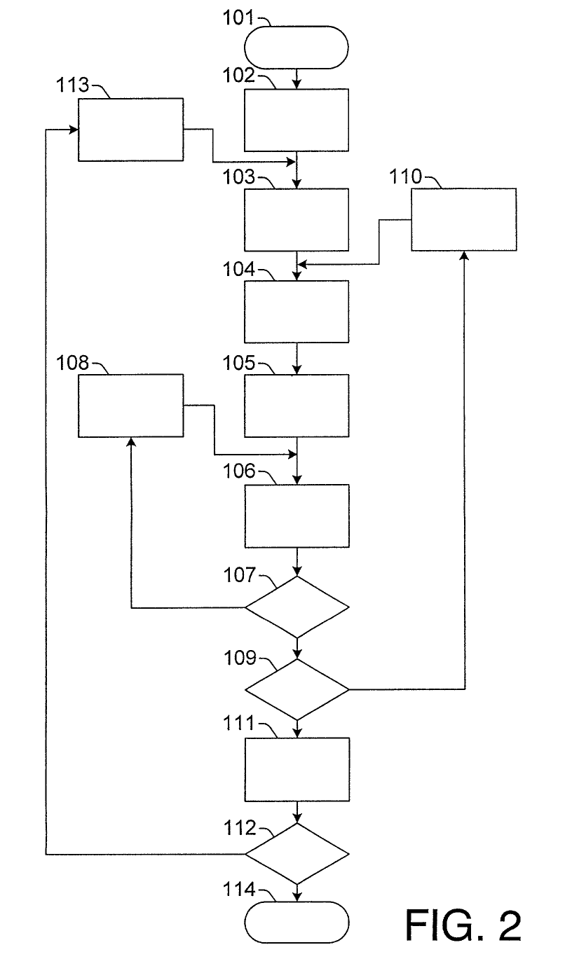

FIG. 2 shows the embodiment of a method according to the invention for the training of parameters of a speech recognition system which are each associated with exactly one pronunciation variant of a word from a vocabulary in the form of a flowchart.

The parameters p(vₗⱼ|wₗ) of a speech recognition system which are associated with exactly one pronunciation variant Vₗⱼ of a word wₗ from a vocabulary may be directly fed to a discriminative optimization of a target function. Eligible target functions are inter alia the sentence error rate, i.e. the proportion of spoken utterances resognized as erroneous (minimum classification error) and the word error rate, i.e. the proportion of words recognized as erroneous. Since these are discrete functions, those skilled in the art will usually apply smoothed versions instead of the actual error rates. Available optimization procedures, for example for minimizing a smoothed error rate, are gradient procedures, inter alia the “generalized probabilistic descent (GPD)”, as well as all other procedures for non-linear optimization such as, for example, the simplex method.

In a preferred embodiment of the invention, however, the optimization probelm is brought into a form which renders possible the use of methods of discriminative model combination. The discriminative model combination is a general method known from WO 99/31654 for the formation of log-linear combinations of individual models and for the discriminative optimization of their weight factors. Accordingly, WO 99/31654 is hereby included in the present application by reference so as to avoid a repeat description of the methods of discriminative model combination.

The scores p(vₗⱼ|wₗ) are not themselves directly used as parameters in the implementation of the methods of discriminative model combination, but instead they are represented in exponential form with new parameters λₗⱼ:

p(vₗⱼ|wₗ)=e^{λlj} (6)

Whereas the parameters λₗⱼ in the known methods of non-linear optimization can be used directly for optimizing the target function, the discriminative model combination aims to achieve a log-linear form of the model scores p(w₁^{N}|x). Fir this purpose, the sum of equation (3) is limited to its main contribuent in an approximation:

p(x|w₁^{N}′)=p(x|\tilde{v}₁^{N}′)·p(\tilde{v}₁^{N}′|w₁^{N}′) (7)

with

$${\tilde{v}}_{1}^{{N}^{′}} = arg {max}_{{v}_{1}^{{N}^{′}}} p ( x \vert {v}_{1}^{{N}^{′}} ) \cdot p ( {v}_{1}^{{N}^{′}} \vert {w}_{1}^{{N}^{′}} ) , \qquad ( 8 )$$

Tal\king into consideration the Bayes' theorem mentioned above (cf. equation 2) and the equations (5) and (7), the desired log-linear expression is found:

$$\begin{matrix}log {p}_{Λ} ( {w}_{1}^{N} \vert x ) = - log {Z}_{Λ} ( x ) + {λ}_{1} log p ( {w}_{1}^{N} ) + \\ {λ}_{2} log p ( x \vert {\tilde{v}}_{1}^{N} ) + {\sum }_{l = 1}^{D} {λ}_{lj} {h}_{lj} ( {\tilde{v}}_{1}^{N} )\end{matrix} \qquad ( 9 )$$

To clarify the dependencies of the individual terms on the parameters Λ=(λ₁, λ₂, . . . , λₗⱼ, . . . ) to be optimized, Λ was introduced as an index in the relevant locations. Furthermore, as is usual in discriminative model combination, the other two summands log p(w₁^{N}) and log p(x|\tilde{v}₁^{N}) were also provided with suitable parameters λ₁ and λ₂. These, however, need not necessarily be optimized, but may be chosen to be equal to 1: λ₁=λ₂=1. Nevertheless, their optimization typically does lead to an improved quality of the speech recognition system. The quantity Z_{λ}(x) depends only on the spoken utterance x (and the parameters Λ) and serves only for normalization, in as far as it is desirable to interpret the score P_{Λ}(w₁^{N}|x) as a probability model; i.e. Z_{λ}(x) is determined such that the normalization condition

$${\sum }_{{w}_{1}^{N}} {p}_{Λ} ( {w}_{1}^{N} \vert x ) = 1$$

is complied with.

The discriminative model combination utilizes inter alia various forms of smoothed word error rates determined during training as target functions. For this purpose, the training set should consist of the H spoeken utterances xₙ, n=1, . . . , H. Each such utterance xₙ has a spoken word sequence ⁽ⁿ⁾w₁^{L}^{ₙ} with a length Lₙ assigned to it, referred to here as the word sequence kₙ for simplicity's sake. kₙ need not necessarily be the actually spoken word sequence; in the case of the so-termed unmonitored adaptation kₙ would be determined, for example, by means of a preliminary recognition step. Furthermore, a quantity ⁽ⁿ⁾kᵢ, i=1, . . . , Kₙ of Kₙ further word sequences, which compete with the spoken word sequence kₙ for the highest score in the recognition process, is determined for each utterance xₙ, for example by means of a recognition step which calculates a so-termed word graph or N-best list. These competing word sequences are denoted k≠kₙ for the sake of simplicity, the symbol k being used as the generic symbol for kₙ and k≠kₙ.

The speech recognition system determines the scores p_{Λ}(kₙ|xₙ) and p_{Λ}(k|xₙ) for the word sequences kₙ and k (≠kₙ), indicating how well they match the spoken utterance xₙ. Since the speech recognition system chooses the word sequence kₙ or k with the highest score as the recognition result, the word error E(Λ) is calculated as the Levenshtein distance Γ between the spoken (or assumed to have been spoken) word sequence kₙ and the chosen word sequence:

$$E ( Λ ) = \frac{1}{{\sum }_{n = 1}^{H} {L}_{n}} {\sum }_{n = 1}^{H} Γ ( {k}_{n} , arg {max}_{k} ( log \frac{{p}_{Λ} ( k \vert {x}_{n} )}{{p}_{Λ} ( {k}_{n} \vert {x}_{n} )} ) ) \qquad ( 10 )$$

This word error rate is smoothed into a continuous function E_{S}(Λ) capable of differentiation by means of an “indicator function” S(k,n,Λ):

$${E}_{S} ( Λ ) = \frac{1}{{\sum }_{n = 1}^{H} {L}_{n}} {\sum }_{n = 1}^{H} {\sum }_{k \neq {k}_{n}} Γ ( {k}_{n} , k ) S ( k , n , Λ ) . \qquad ( 11 )$$

The indicator function S(k,n,Λ) should be close to 1 for the word sequence with the highest score chosen by the speech recognition system, whereas it should be close to 0 for all other word sequences. A possible choice is:

$$S ( k , n , Λ ) = \frac{{{p}_{Λ} ( k \vert {x}_{n} )}^{η}}{{\sum }_{{k}^{′}} {{p}_{Λ} ( {k}^{′} \vert {x}_{n} )}^{η}} \qquad ( 12 )$$

with a suitable constant η, which may be chosen to be 1 in the simplest case.

The target function of equation 11 may be optimized, for example, by means of an iterative gradient method, such that after implementation of the respective partial derivations the following iterative equation for the parameters λₗⱼ of the pronunciation variants will be obtained by those skilled in the art:

$${λ}_{lj}^{( I + 1 )} = {λ}_{lj}^{( I )} - \frac{ϵ \cdot η}{{\sum }_{n = 1}^{H} {L}_{n}} {\sum }_{n = 1}^{H} {\sum }_{k \neq {k}_{n}} S ( k , n , {Λ}^{( I )} ) \cdot \tilde{Γ} ( k , n , {Λ}^{( I )} ) \cdot [ {h}_{lj} ( \tilde{v} ( k ) ) - {h}_{lj} ( \tilde{v} ( {k}_{n} ) ) ] . \qquad ( 13 )$$

An iteration step with step width ε will yield the die parameters λₗⱼ^{(I+1)}of the (I+1)^{th} iteration step from the parameters λₗⱼ^{(I)} der I^{th} iteration step, \tilde{v}(k) and \tilde{v}(kₙ) denote the pronunciation variants with the highest scores (in accordance with equation 8) for the word sequences k and kₙ, and \tilde{Γ}(k,n,Λ) is short for:

$$\tilde{Γ} ( k , n , Λ ) = Γ ( k , {k}_{n} ) - {\sum }_{{k}^{′} \neq {k}_{n}} S ( {k}^{′} , n , Λ ) Γ ( {k}^{′} , {k}_{n} ) . \qquad ( 14 )$$

Since the quantity \tilde{Γ}(k,n,Λ) is the deviation of the error rate Γ(k,kₙ) around the error rate of all word sequences weighted with S(k′,n,Λ) , it is possible to characterize word sequences k with \tilde{Γ}(k,n,Λ)<0 as correct word sequences because they exhibit an error rate lower than the one weighted with S(k′,n,Λ) . The iteration rule of equation 13 accordingly stipulates that the parameters λₗⱼ, and thus the scores p(vₗⱼ|wₗ) are to be enlarged for those pronunciation variants vₗⱼ, die, judging from the spoken word sequence kₙ, occur frequently in correct word sequences, i.e. for which it holds that hₗⱼ(\tilde{v}(kₙ))−hₗⱼ(\tilde{v}(kₙ)>0 in correct word sequences. A similar rule applies to variants which occur only seldom in bad word sequences. On the other hand, the scores are to be lowered for variants which occur only seldom in good word sequences and frequently in bad ones. This interpretation is a good example of the advantageous effect of the invention.

FIG. 1 shows an embodiment of a system according to the invention for the training of parameters of a speech recognition system wherein exactly one pronunciation variant of a word is associated with a parameter. A method according to the invention for the training of parameters of a speech recognition system which are associated with exactly one pronunciation variant of a word is carried out on a computer 1 under the control of a program stored in a program memory 2. A microphone 3 serves to record spoken utterances, which are stored in a speech memory 4. It is alternatively possible for such spoken utterances to be transferred into the speech memory from other data carriers or via networks instead of through recording via the microphone 3.

Parameter memories 5 and 6 serve to store the parameters. It is assumed that in this embodiment an iterative optimization process of the kind discussed above is carried out. The parameter memory 5 then contains, for example, for the calculation of the (I+1)^{th} iteration step the parameters of the I^{th} iteration step known at that stage, while the parameter memory 6 receives the new parameters of the (I+1)^{th} iteration step. In the next stage, i.e. the (I+2)^{th} iteration step in this example, the parameter memories 5 and 6 will exchange roles.

A method according to the invention is carried out on a general-purpose computer 1 in this embodiment. This will usually contain the memories 2, 5, and 6 in one common arrangement, while the speech memory 4 is more likely to be situated in a central server which is accessible via a network. Alternatively, however, special hardware may be used for implementing the method, which hardware may be constructed such that the entire method or parts thereof can be carried out particularly quickly.

FIG. 2 shows the embodiment of a method according to the invention for the training of parameters of a speech recognition system which are each associated with exactly one pronunciation variant of a word from a vocabulary in the form of a flowchart. After the start block 101, in which general preparatory measures are taken, the start values Λ⁽⁰⁾ for the parameters are chosen in block 102, and the iteration counter variable I is set for 0: I=0. A “maximum likelihood” method as described above may be used for estimating the scores p(vₗⱼ|wₗ), from which the start values of λₗⱼ⁽⁰⁾ are subsequently obtained through formation of the logarithm function.

Block 103 starts the progress through the training set of spoken utterances, for which the counter variable n is set for 1: n=1. The selection of the competing word sequences k≠kₙ so as to match the spoken utterance xₙ takes place in block 104. If the spoken word sequence k. matching the spoken utterance xₙ is not yet known from the training data, it may be estimated here by means of the updated parameter formation of the speech recognition system in block 104. It is also possible, however, to carry out such an estimation once only in advance, for example in block 102. Furthermore, a separate speech recognition system may alternatively be used for estimating the spoken word sequence kₙ.

In block 105, the progress through the quantity of competing word sequences k≠kₙ is started, for which purpose the counter variable k is set for 1: k=1. The calculation The calculation of the individual terms and the accumulation of the double sum arising in equation 13 from the counter variables n and k take place in block 106. It is tested in the decisin block 107, which limits the progress through the quantity of competing word sequences k≠kₙ, whether any further competing word sequences k≠kₙ are present. If this is the case, the control switches to block 108, in which the counter variable k is increased by 1: k=k+1, whereupon the control goes to block 106 again. If not, the control goes to decision block 109, which limits the progress through the training set of spoken utterances, for which purpose it is tested whether any further training utterances are available. If this is the case, the counter variable n is increased by 1: n=n+1, in block 110 and the control returns to block 104 again. If not, the progress through the training quantity of spoken utterances is ended and the control is moved to block 111.

In block 111, the new values of the parameters Λ are calculated, i.e. in in the first iteration step I=1 the values Λ⁽¹⁾. In the subsequent decision block 112, a stop criterion is applied so as to ascertain whether the optimization has been sufficiently converged. Various methods are known for this. For example, it may be required that the relative changes of the parameters or those of the target functions should fall below a given threshold. In any case, however, the iteration may be broken off after a given maximum number of iteration steps.

If the iteration has not yet been sufficiently converged, the iteration counter variable I is increased by 1 in block 113: I=I+1, whereupon in Block 103 the iteration loop is entered again. In the opposite case, the iteration is concluded with general rearrangement measures in block 114.

A special iterative optimization process was described in detail above for determining the parameters λₗⱼ, but it will be clear to those skilled in the art that other optimization methods may alternatively be used. In particular, all methods known in connection with discriminative model combination are applicable. Special mention is made here again of the methods disclosed in WO 99/31654. This describes in particular also a method which renders it possible to determine the parameters non-iteratively in a closed form. The parameter vector Λ is then obtained through solving of a linear equation system having the form Λ=Q⁻¹P, wherein the matrix Q and the vector P result from score correlations and the target function. The reader is referred to WO 99/31654 for further details.

After the parameters λₗⱼ have been determined, they can be used for selecting the pronunciation variants vₗⱼ also included in the pronunciation lexicon. Thus, for example, variants vₗⱼ with scores p(vₗⱼ|wₗ), which are below a given threshold value, may be removed from the pronunciation lexicon. Furthermore, a pronunciation lexicon may be created with a given number of variants vₗⱼ in that a suitable number of variants vₗⱼ having the lowest scores p(vₗⱼ|wₗ) are deleted.

1. A method of training parameters of a speech recognition system, each parameter being associated with exactly one pronunciation variant of a word from a vocabulary, which method comprises the steps of:
making available a training set of acoustical speech signals, and
determining the parameters through discriminative optimization of a target function.

2. A method as claimed in claim 1, characterized in that the parameter λₗⱼ associated with the j^{th} pronunciation variant vₗⱼ of the l^{th} word wₗ from the vocabulary has the following exponential relationship with a score p(vₗⱼ|wₗ), such that the word wₗ is pronounced as the pronunciation variant vₗⱼ:
p(vₗⱼ|wₗ)=e^{λ}^{ₗⱼ}

3. A method as claimed in claim 1 or 2, characterized in that the target function is calculated as a continuous function, which is capable of differentiation, of the following quantities:
the respective Levenshtein distances Γ(kₙ,k) between a spoken word sequence kₙ associated with a corresponding acoustical speech signal xₙ from the training set and further word sequences k≠kₙ associated with the speech signal and competing with kₙ, and
respective scores p_{Λ}(k|xₙ) and p_{Λ}(kₙ|xₙ) indicating how well the further word sequences k≠kₙ and the spoken word sequence kₙ match the speech signal xₙ.

4. A method as claimed in any one of the claims 1 to 3, characterized in that
a probability model is used as said respective score p(vₗⱼ|wₗ), representing the probability that the word wₗ is pronounced as the pronunciation variant vₗⱼ and
a probability model is used as said respective score p_{Λ}(kₙ|xₙ), representing the probability that the spoken word sequence kₙ associated with the corresponding acoustical speech signal xₙ from the training set is spoken as the speech signal xₙ, and/or
a probability model is used as said respective score p_{Λ}(k|xₙ), representing the probability that the relevant competing word sequence k≠kₙ is spoken as the speech signal xₙ.

5. A method as claimed in any one of the claims 1 or 4, characterized in that the discriminative optimization of the target function is carried out by one of the methods of discriminative model combination.

6. A system for the training of parameters of a speech recognition system, each parameter being associated with exactly one pronunciation variant of a word from a vocabulary, which system is designed for:
making available a training set of acoustical speech signals, and
determining the parameters through discriminative optimization of a target function.

7. A method of training parameters of a pattern recognition system, each parameter being associated with exactly one realization variant of a pattern from an inventory, which method comprises the steps of:
making available a training set of patterns, and
determining the parameters through discriminative optimization of a target function.

8. A system for the training of parameters of a pattern recognition system, each parameter being associated with exactly one realization variant of a pattern from an inventory, which system is designed for:
making available a training set of patterns, and
determining the parameters through discriminative optimization of a target function.

9. Parameters of a pattern recognition system which are each associated with exactly one realization variant of a pattern from an inventory and which were generated by means of a method as claimed in claim 7.

10. A data carrier with parameters of a pattern recognition system as claimed in claim 9.
